(19) United States
(12) Patent Application Publication
(10) Pub. No.: US 2018/0346810 A1
(43) Pub. Date: Dec. 6, 2018

(54) NANOCRYSTAL EPOXY THIOL (METH)ACRYLATE COMPOSITE MATERIAL AND NANOCRYSTAL EPOXY THIOL (METHACRYLATE) COMPOSITE FILM

(71) Applicant: Henkel AG & Co. KGaA, Dusseldorf (DE)

(72) Inventor: Lirong Chao, Irvine, CA (US)

(21) Appl. No.: 16/100,917

(22) Filed: Aug. 10, 2018

Related U.S. Application Data
(63) Continuation of application No. PCT/EP2017/052002, filed on Jan. 31, 2017.
(60) Provisional application No. 62/295,568, filed on Feb. 16, 2016.

(51) Int. Cl. C09K 11/88; C09K 11/02

(52) U.S. Cl. CPC C09K 11/883; B82Y 30/00; C09K 11/02

(57) ABSTRACT

The present invention relates to a nanocrystal composite comprising a) a plurality of nanocrystals comprising a core comprising a metal or a semiconductive compound or a mixture thereof and at least one ligand, wherein said core is surrounded by at least one ligand, b) a polymeric matrix, wherein said polymeric matrix is formed by radical polymerisation of (meth)acrylate having functionality from 2 to 10 and thermal induced reaction of epoxy having functionality from 2 to 10 and polythiol having functionality from 2 to 10, and wherein said nanocrystals are embedded into said polymeric matrix.

### TECHNICAL FIELD OF THE INVENTION

The present invention relates to a nanocrystal composite comprising nanocrystals in polymeric matrix. Composites of the present invention provide thermal and photothermal stability to the nanocrystals.

### BACKGROUND OF THE INVENTION

Semiconductor nanocrystals can be used as light down-converters, i.e., shorter wavelength light is converted to longer wavelength light. The nanocrystal (NC) composites are used in a broad range of applications including displays, lighting, security inks, bio-labelling and solar concentrators. In all the cases, the NC composites are exposed to a certain light flux and temperature. The exposure of the NC composites to photons and temperature under the presence of air and moisture causes decrease of the optical properties of the composite.

NC composites are used in light down-conversion applications. The state of the art NC composites degrade by exposure to temperature and photons over time. To improve the stability of the NCs, the composites need an additional protection against oxygen and moisture e.g. by a high performance barrier film or glass encapsulation. To avoid the presence of air and moisture in the encapsulated NC composite, the manufacturing has to be performed under inert atmosphere.

NCs are synthesized in solution and can be further embedded in polymer matrices that act as a carrier and first protective layer. Physical mixing of NC solutions with a polymer solution or a crosslinking formulation is a common approach used in the art to obtain NC-polymer composite materials.

The most common matrices for NC composites used in down-conversion are based on acrylate or epoxy resins. Rapid curing speed initiated by UV irradiation and/or elevated temperatures makes them easy to process for large scale film manufacturing. NCs embedded in acrylate- or epoxy-based matrices tend to degrade under operation conditions. Therefore, an additional barrier film is needed to prevent the permeability of oxygen and moisture inside the adhesive, which increases the cost and thickness of the final product.

To overcome the problems related to the thermal and photon degradation of the NCs, two approaches have been used and reported. In the first approach, an epoxy-amine resin containing NCs are placed between barrier layers. However, this approach provides thicker products and is more expensive to produce. Despite the use of the barrier layers, oxygen and moisture still penetrate the unprotected edges of the product, and leads to a degradation in these areas. Meaning that with the currently available barrier films, the photothermal and thermal reliability is not always sufficient. Furthermore, current barrier films do not provide sufficient barrier protection at the cut edge of the QD films, which leads to edge ingress. The width of such inactive edges grows with aging time. In the second approach, the NCs are embedded in an acrylic polymerizable formulation and subsequently, further encapsulate the NC composite is further encapsulated inside a glass tube. The process requires a sophisticated manufacturing line under oxygen and/or moisture free environment. Furthermore, such fragile products require a modification of the product architecture and manufacturing process.

In a further approach, thiols have been used, as a part of the adhesive matrix for quantum dot (QD) composites. Thiols have been found to be beneficial for their thermal stability broadening the range of matrix chemistries with a good QD dispersion. However, degradation caused by photons cannot be prevented completely in combination with state of the art polymer matrices.

Therefore, there is still a need for a nanocrystal composites comprising barrier layers, which provide improved thermal and photothermal stability to the nanocrystals.

### SUMMARY OF THE INVENTION

The present invention relates to a nanocrystal composite comprising a) a plurality of nanocrystals comprising a core comprising a metal or a semiconductive compound or a mixture thereof and at least one ligand, wherein said core is surrounded by at least one ligand, b) a polymeric matrix, wherein said polymeric matrix is formed by radical polymerisation of (meth)acrylate having functionality from 2 to 10 and thermal induced reaction of epoxy having functionality from 2 to 10 and polythiol having functionality from 2 to 10, wherein said nanocrystals are embedded into said polymeric matrix.

The present invention also relates to a cured nanocrystal composite according to the present invention.

The present invention encompasses a film comprising a nanocrystal composite according to the present invention, wherein said film comprises a first barrier film and a second barrier film, wherein said nanocrystal composite is between the first and second barrier film.

The present invention also encompasses a product comprising a nanocrystal composite according to the present invention, wherein said product is selected from the group consisting of a display device, a light emitting device, a photovoltaic cell, a photodetector, an energy converter device, a laser, a sensor, a thermoelectric device, a security ink, lighting device and in catalytic or biomedical applications.

The present invention also relates to a use of nanocrystal composite according to the present invention as a source of photoluminescence or electroluminescence.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in the disclosing invention, including technical and scientific terms, have the meaning as commonly understood by one of the ordinary skill in the art to which this invention belongs to. By means of further guidance, term definitions are included to better appreciate the teaching of the present invention.

As used herein, the use of the term “(meth)” followed by another term such as acrylate refers to both acrylates and methacrylates. For example, the term “(meth)acrylate” refers to either acrylate or methacrylate.

The present invention addresses a class of polymer matrices, which act itself as a protection to the NCs.

The present invention provides a nanocrystal composite comprising a) a plurality of nanocrystals comprising a core comprising a metal or a semiconductive compound or a mixture thereof and at least one ligand, wherein said core is surrounded by at least one ligand, b) a polymeric matrix, wherein said polymeric matrix is formed by radical polymerisation of (meth)acrylate having functionality from 2 to 10 and thermal induced reaction of epoxy having functionality from 2 to 10 and polythiol having functionality from 2 to 10, wherein said nanocrystals are embedded into said polymeric matrix.

The nanocrystal composite according to the present invention provides increased photothermal and thermal stability for the nanocrystals. In addition, nanocrystal composite according to the present invention provides smaller edge ingress and is easy to process.

All features of the present invention will be discussed in detail.

A NC composite according to the present invention comprises a plurality of NCs comprising a core comprising a metal or a semiconductive compound or a mixture thereof.

The core of the NCs according to the present invention has a structure including the core alone or the core and one or more shell(s) surrounding the core. Each shell may have structure comprising one or more layers, meaning that each shell may have monolayer or multilayer structure. Each layer may have a single composition or an alloy or concentration gradient.

In one embodiment, the core of the NCs according to the present invention has a structure comprising a core and at least one monolayer or multilayer shell. Yet, in another embodiment, the core of the nanocrystals according to the present invention has a structure comprising a core and at least two monolayer and/or multilayer shells.

Preferably, the size of the core of the NCs according to the present invention is less than 100 nm, more preferably less than 50 nm, more preferably less than 10 nm, however, preferably the core is larger than 1 nm. The particle size is measured by using transmission electron microscopy (TEM).

The shape of the nanocrystal can be chosen from a broad range of geometries. Preferably the shape of the core of the NCs according to the present invention is spherical, rectangular, rod, tetrapod, tripod or triangle shape.

The core of the NCs is composed of a metal or a semiconductive compound or a mixture thereof. Moreover, metal or semiconductive compound is combination of one or more elements selected from combination of one or more different groups of the periodic table.

Preferably, metal or semiconductive compound is combination of one or more elements selected from the group IV; one or more elements selected from the groups II and VI; one or more elements selected from the groups III and V; one or more elements selected from the groups IV and VI; one or more elements selected from the groups I and III and VI or a combination thereof.

More preferably said metal or semiconductive compound is selected from the group consisting of Si, Ge, SiC, SiGe, CdS, CdSe, CdTe, ZnS, ZnSe ZnTe, ZnO, HgS, HgSe, HgTe, MgS, MgSe, GaN, GaP, GaSb, AlN, AlP, AlAs, AlSb₃, InN₃, InP, InAs, SnS, SnSe, SnTe, PbS, PbSe, PbTe, CuInS₂, CuInSe₂, CuGaS₂, CuGaSe₂, AgInS₂, AgInSe₂, AgGaS₂ and AgGaSe₂, and even more preferably said metal or semiconductive compound is selected from group consisting of CdSe, InP and mixtures thereof.

Preferred metal or semiconductive compounds provide better optical properties. CdSe is highly preferred because it provides best optical properties, on the other hand, InP provides best optical properties of Cd free NCs, and is therefore, less toxic.

Preferably, NCs according to the present invention have a particle diameter (e.g. largest particle diameter, including core and shell) ranging from 1 nm to 100 nm, preferably from 1 nm to 50 nm and more preferably from 1 nm to 15 nm. The particle size is measured by using transmission electron microscopy (TEM).

The core of the NCs is surrounded by at least one ligand. Preferably, the whole surface of the NCs is covered by ligands. It is believed by the theory that when the whole surface of the NC is covered by ligands the optical performance of the NC is better.

Suitable ligands for use in the present invention are alkyl phosphines, alkyl phosphine oxides, amines, thiols, polythiols, carboxylic acids and phosphonic acids and similar compounds and mixtures thereof.

Examples of suitable alkyl phosphines for use in the present invention as a ligand are tri-n-octylphosphine, trishydroxylpropylphosphine, tributylphosphine, tri(dodecyl)phosphine, dibutyl-phosphite, tributyl phosphite, trioctadecyl phosphite, trilauryl phosphite, tris(tridecyl) phosphite, triisodecyl phosphite, bis(2-ethylhexyl)phosphate, tris(tridecyl) phosphate and mixtures thereof.

Example of suitable alkyl phosphine oxides for use in the present invention as a ligand is tri-n-octylphosphine oxide.

Examples of suitable amines for use in the present invention as a ligand are oleylamine, hexadecylamine, octadecylamine, bis(2-ethylhexyl)amine, dioctylamine, trioctylamine, octylamine, dodecylamine/laurylamine, didodecylamine, tridodecylamine, dioctadecylamine, trioctadecylamine and mixtures thereof. Primary amines are preferred as ligands due to less steric hindrance.

Examples of suitable thiol for use in the present invention as a ligand is 1-dodecanethiol.

Examples of suitable thiols for use in the present invention as a ligand are pentaerythritol tetrakis (3-mercaptobutylate), pentaerythritol tetrakis(3-mercaptopropionate), trimethylolpropane tri(3-mercaptopropionate), tris[2-(3-mercaptopropionyloxy) ethyl]isocyanurate, dipenta-erythritol hexakis(3-mercaptopropionate), ethoxilatedtri-methylolpropan tri-3-mercapto-propionate and mixtures thereof.

Thiols can also be used in the present invention in their deprotonated form.

Examples of suitable carboxylic acids and phosphonic acids for use in the present invention as a ligand are oleic acid, phenylphosphonic acid, hexylphosphonic acid, tetradecylphosphonic acid, octylphosphonic acid, octadecylphosphonic acid, propylenediphosphonic acid, phenylphosphonic acid, aminohexylphosphonic acid and mixtures thereof.

Carboxylic acids and phosphonic acids can also be used in the present invention in their deprotonated form.

Examples of other suitable ligands for use in the present invention are dioctyl ether, diphenyl ether, methyl myristate, octyl octanoate, hexyl octanoate, pyridine and mixtures thereof.

Selected ligands stabilize the NC in a solution.

Commercially available NC for use in the present invention is for example CdSeS/ZnS from Sigma Aldrich.

A NC composite according to the present invention comprises NCs from 0.01 to 10% by weight of the total weight of the composite, preferably from 0.05 to 7.5%, more preferably from 0.1 to 5%.

NC composites could also be prepared with higher NC quantity, however, if the quantity is >10% the optical properties of the QDs will be negatively affected due to interactions between them. On the other hand if the quantity is <0.01%, the formed films would exhibit very low brightness.

According to the present invention NCs are embedded into the polymeric matrix. A nanocrystal composite according to the present invention comprises a polymer matrix from 90 to 99.99% by weight of the total weight of the composite, preferably from 92.5 to 99.95%, more preferably from 95 to 99.9%. If the polymeric matrix quantity is lower than 90% and the quantity of NCs is more than 10%, the optical properties of the nanocrystals will be negatively affected due to interactions between them.

Suitable polymeric matrix for the present invention is an epoxy thiol (meth)acrylate matrix. Polymeric matrix according to the present invention is formed by curing (meth)acrylate first radically to form a homopolymer, and subsequently, curing epoxy and polythiol thermally to form a polymeric matrix.

The Applicant has discovered that the polymeric matrix according to the present invention provides high thermal and photothermal stability to the NCs.

A polymeric matrix according to the present invention is formed by radical polymerisation of (meth)acrylate having functionality from 2 to 10 and thermal induced reaction of epoxy having functionality from 2 to 10 and polythiol having functionality from 2 to 10.

A polymeric matrix according to the present invention is formed by radical polymerisation of (meth)acrylate having functionality from 2 to 10, preferably from 2 to 6, and more preferably from 2 to 4.

Suitable (meth)acrylate for use in the present invention is selected from the group consisting of:

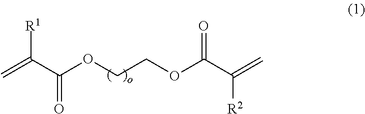

wherein o is 2-10, preferably o is 3-5, R¹ and R² are same or different and are independently selected from H, —CH₃, —C₂H₅, preferably R¹ and R² are —CH₃;

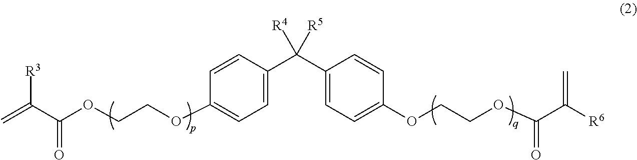

wherein p is 0-10, q is 0-10, R³, R⁴, R⁵ and R⁶ are same or different and are independently selected from H, —CH₃, —C₂H₅, preferably R³, R⁴, R⁵ and R⁶ are same or different and are independently selected from H, —CH₃, preferably R³ and R⁶ are —CH₃;

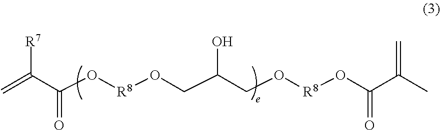

wherein e is 0-10, q is 0-10, R⁷, is selected from H, —CH₃, —C₂H₅, preferably R⁷ is selected from H, —CH₃; R⁸ is selected from

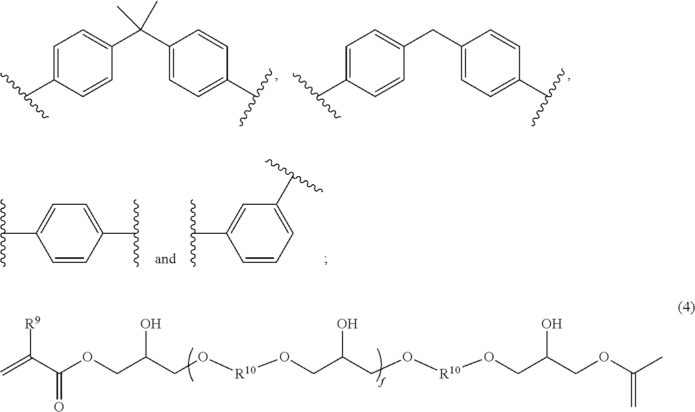

wherein e is 0-10, q is 0-10, R⁹, is selected from H, —CH₃, —C₂H₅, preferably R⁹ is selected from H, —CH₃; R¹⁰ is selected from

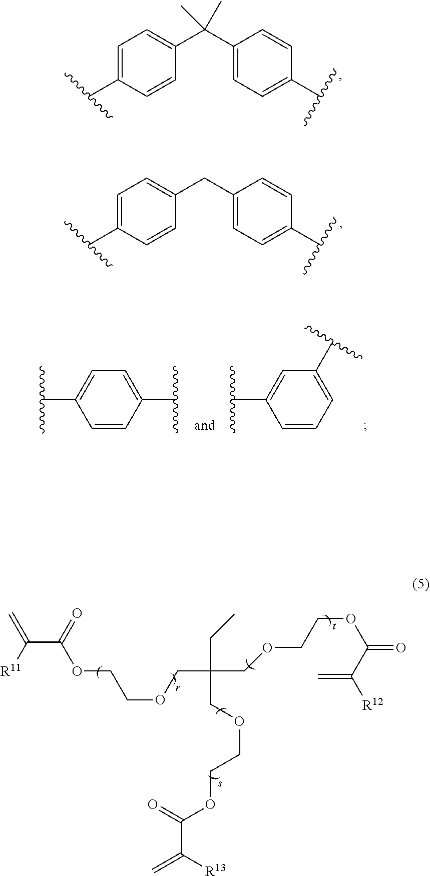

wherein r is 0-10, s is 0-10, t is 0-10, R¹¹, R¹² and R¹³ are same or different and are independently selected from H, —CH₃, —C₂H₃, preferably R¹¹, R¹² and R¹³ are —CH₃;

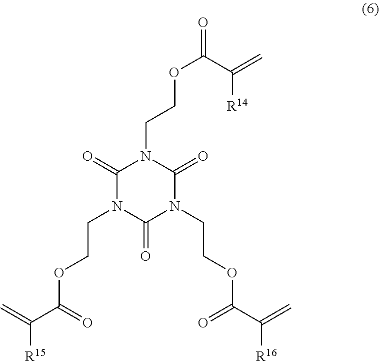

wherein, R¹⁴, R¹⁵ and R¹⁶ are same or different and are independently selected from H, —CH₃, —C₂H₅, preferably R¹⁴, R¹⁵ and R¹⁶ are —CH₃;

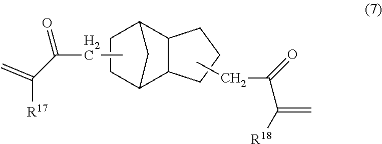

wherein, R¹⁷ and R¹⁸ are same or different and are independently selected from H, —CH₃, —C₂H₅, preferably R¹⁷ and R¹⁸ are —CH₃; and mixtures thereof.

Preferably, said (meth)acrylate is selected from the group consisting of ethoxylated bisphenol A diacrylate having three ethoxy groups, ethoxylated bisphenol A diacrylate having two ethoxy groups, 1,6-hexanediol diacrylate, trimethylolpropane trimethacrylate, ethoxylated trimethylolpropane triacrylate having three ethoxy groups, bis A epoxy methacrylate, tricyclodecane dimethanol diamethacrylate, and mixtures thereof, more preferably selected from the group consisting of bis A epoxy methacrylate, tricyclodecane dimethanol diamethacrylate and mixtures thereof.

Above mentioned preferred (meth)acrylates are preferred because they provide ideal curing speed, transparency and good optical properties. In addition, they provide stability for QDs, aspecially the BisA acrylate provides good barrier properties. On the other hand, 1,6-hexanediol diacrylate has a low viscosity and can be used as reactive diluent.

Commercially available (meth)acrylates suitable for use in the present invention are SR 349, SR 348, SR 238 and CN154 from Sartomer.

Suitable polymeric matrix for use in the present invention may also be formed from (meth)acrylate epoxy oligomer. Suitable (meth)acrylate epoxy oligomer for use in the present invention is selected from the group consisting of:

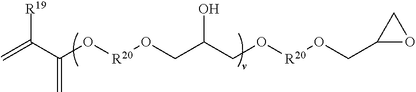

wherein v is 0-10, q is 0-10, R¹⁹, is selected from H, —CH₃, —C₂H₅, preferably R¹⁹ is selected from H, —CH₃; R²⁰ is selected from

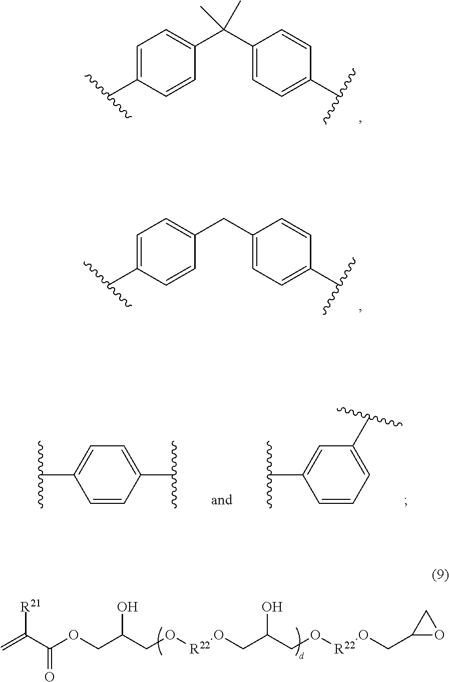

wherein d is 0-10, q is 0-10, R²¹, is selected from H, —CH₃, —C₂H₅, preferably R²¹ is selected from H, —CH₃; R²² is selected from

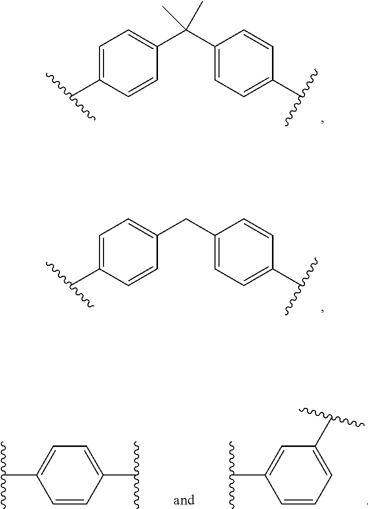 [SMILES: *c1ccc(C(C)(C)c2ccc(*)cc2)cc1 ; *c1ccc(Cc2ccc(*)cc2)cc1 ; *c1ccc(*)cc1 ; *c1cccc(*)c1]

A nanocrystal composite according to the present invention has a (meth)acrylate content from 1 to 50% by weight of the total weight of the polymeric matrix, preferably from 5 to 30%, more preferably from 10 to 20%.

Quantity of 10-20% by weight of the total weight of the polymeric matrix is preferred because this is a suitable quantity leading to a “pregelling” of the film prior to the thermal epoxy cure.

A polymeric matrix according to the present invention is formed from polythiols having functionality from 2 to 10, preferably from 2 to 6, more preferably from 2 to 4 and even more preferably from 3 to 4.

Suitable polythiol for use in the present invention is selected from the group consisting of:

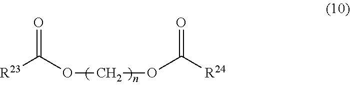

wherein n is 2-10, R²³ and R²⁴ are same or different and are independently selected from —CH₂—CH(SH)CH₃ and —CH₂—CH₂—SH;

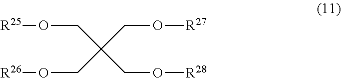

wherein R²⁵, R²⁶, R²⁷ and R²⁸ are same or different and are independently selected from —C(O)—CH₂—CH₂—SH, —C(O)—CH₂—CH(SH)CH₃, —CH₂—C(—CH₂—O—C(O)—CH₂—CH₂—SH)₃, —C(O)—CH₂—SH, —C(O)—CH(SH)—CH₃;

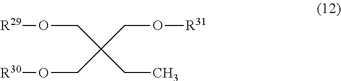

wherein R²⁹, R³⁰ and R³¹ are same or different and are independently selected from —C(O)—CH₂—CH₂—SH, —C(O)—CH₂—CH(SH)CH₃, —[CH₂—CH₂—O—]ₒ—C(O)—CH₂—CH₂—SH, —C(O)—CH₂—SH, —C(O)—CH(SH)—CH₃ and o is 1-10;

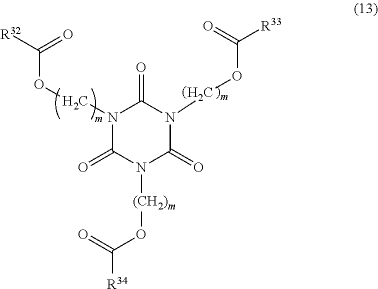

wherein m is 2-10, R³², R³³ and R³⁴ are same or different and independently selected from —CH₂—CH₂SH, —CH₂—CH(SH)CH₃, —C(O)—CH₂—SH, —C(O)—CH(SH)—CH₃; and mixtures thereof.

Preferably said polythiol is selected from the group consisting of glycol di(3-mercaptopropionate), pentaerythritol tetrakis (3-mercaptobutylate), 1,3,5-tris(3-mercaptobutyloxethyl)-1,3,5-triazine-2,4,6(1H,3H,5H)-trione, 1,4-bis (3-mercaptobutylyloxy) butane, tris[2-(3-mercaptopropionyloxy)ethyl]isocyanurate, pentaerythritol tetrakis(3-mercaptopropionate), trimethylolpropane tris(3-mercaptopropionate), trimethylolpropane tris(3-mercaptobutyrate), ethoxylated-trimethylolpropane tri-3-mercaptopropionate, dipentaerythritol hexakis (3-mercaptopropionate) and mixtures thereof, more preferably said polythiol is primary thiol, selected from the group consisting of glycol di(3-mercaptopropionate), tris[2-(3-mercaptopropionyloxy)ethyl]isocyanurate, pentaerythritol tetra(3-mercaptopropionate), trimethylolpropane tris(3-mercaptopropionate), ethoxylated-trimethylolpropane tri-3-mercaptopropionate, dipentaerythritol hexakis (3-mercaptopropionate) and mixtures thereof, and even more preferably said polythiol is selected from the group consisting of tris[2-(3-mercaptopropionyloxy)ethyl]isocyanurate, pentaerythritol tetra(3-mercaptopropionate), trimethylolpropane tris(3-mercaptopropionate) and mixtures thereof.

Preferred polythiols are desired due the fact that they provide appropriate viscosity and curing speed (within minutes to 1 hour). In addition, preferred thiols in combination with epoxides and/or (meth)acrylates and nanocrystals result in a film with the desired mechanical properties—a film, which is not too brittle or rubbery and adheres well to the barrier films.

Commercially available polythiols suitable for use in the present invention is Thiocure® TMPMP from Bruno Bock.

A nanocrystal composite according to the present invention has a thiol content from 10 to 90% by weight of the total weight of the polymeric matrix, preferably from 20 to 80%, more preferably from 30 to 70%.

Adequate quantity of thiol is needed for a complete and good cure. If the amount of thiol is too low the matrix is not cured. A slight excess of thiol may be beneficial for the optical properties, this is because it leads to a maximum conversion of the epoxy groups. Unreacted epoxy groups are detrimental for the thermal stability.

A polymeric matrix according to the present invention is formed from epoxides having functionality from 2 to 10, preferably from 2 to 6, and more preferably from 2 to 4.

Suitable epoxide for use in the present invention is selected from the group consisting of:

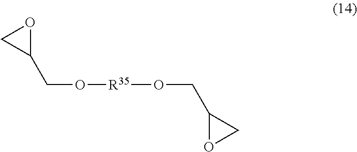

wherein R³⁵ is selected from

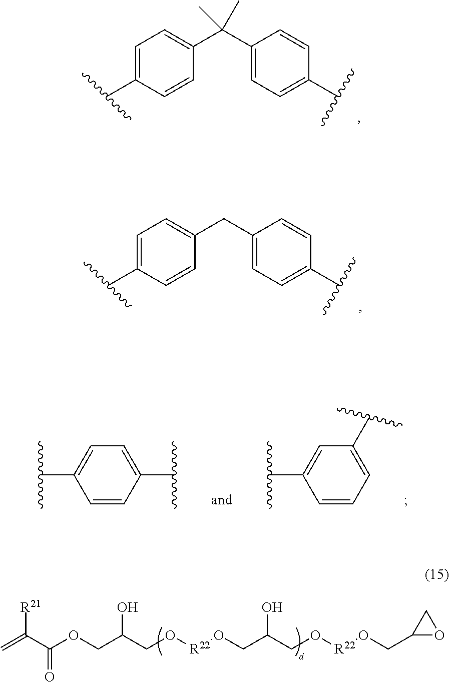

wherein a is 2-10, preferably 4-6 and R³⁶ is selected from

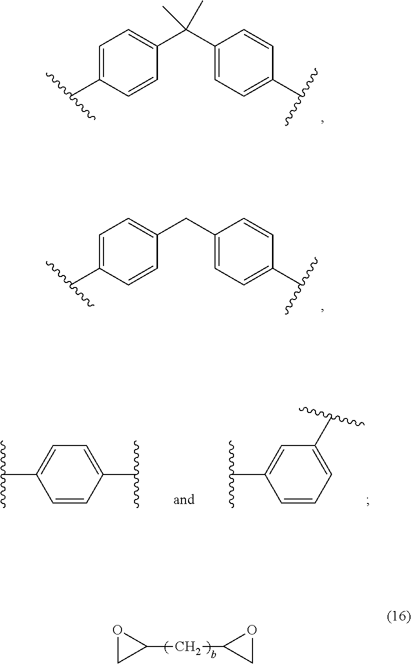

wherein b is 2-10, preferably 4-6, more preferably b is 4;

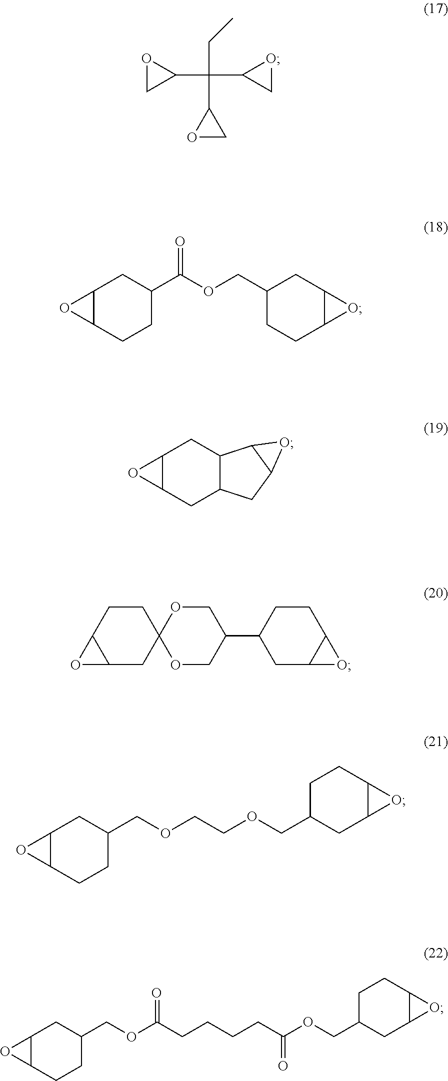 [SMILES: CCC(C1CO1)(C1CO1)C1CO1 ; O=C(OCC1CCC2OC2C1)C1CCC2OC2C1 ; C1C2CC3OC3C2CC2OC12 ; C1CC2OC2CC1C1COC2(CCC3OC3C2)OC1 ; C(COCC1CCC2OC2C1)OCC1CCC2OC2C1 ; O=C(CCCCC(=O)OCC1CCC2OC2C1)OCC1CCC2OC2C1]

and mixtures thereof.

Preferably said epoxy is selected from the group consisting of 2,2-Bis[4-(glycidyloxy)phenyl]propane, bisphenol A diglycidyl ether, 1,4-butanediol diglycidyl ether, bisphenol F glycidyl ether, bisphenol A based oligomers and mixtures thereof.

Bis A epoxy is preferred epoxy because of its transparency and good reactivity. On the other hand, cycloaliphatic epoxies can be used however they have slower cure and need higher temperature, which is not beneficial for the NCs.

Commercially available epoxides suitable for use in the present invention are DER 332 and DER 331 from DOW and Epon 825, Epon 826, Epon 827, Epon 828 from Hexion.

Suitable polymeric matrix for use in the present invention may also be formed from (meth)acrylate epoxy oligomer.

A nanocrystal composite according to the present invention has an epoxy content from 10 to 90% by weight of the total weight of the polymeric matrix, preferably from 20 to 80%, more preferably from 30 to 70%.

Adequate quantity of epoxy is needed for a complete and good cure. A slight excess of thiol may be beneficial for the optical properties, this is because it leads to a maximum conversion of the epoxy groups.

Since there is no radical initiator in the composition, the (meth)acrylate is cured by the thiol. If the (meth)acrylate quantity is above 80%, the composition will not cure completely.

The NC composites according to the present invention may be cured by a thermal initiator, which is preferably a base or by a photoinitiator, which is releases a base upon excitation by light.

The NC composites according to the present invention may further comprise a photoinitiator or a thermal initiator.

Suitable thermal initiators for use in the present invention are organic bases such as dimethylacetamide, dimethylformamide, trimethylamine, 1,8-Diazabicyclo[5.4.0]undec-7-ene, 1,5-Diazabicyclo[4.3.0]non-5-ene and ethylmethylimidazole, imidazole among others.

A NC composite according to the present invention may comprise a thermal initiator from 0 to 6% by weight of the total weight of the composite, preferably from 0.01 to 3%, more preferably from 0.01 to 2%.

Suitable photoinitiators for use in the present invention are for example 1,5,7-triazabicyclo[4.4.0]dec-5-ene.hydrogen tetraphenyl borate (TBD.HBPh₄), 2-methyl-4-(methylthio)-2-morpholinopropiophenone, 2-(9-Oxoxanthen-2-yl)propionic acid-1,5,7 triazabicyclo[4.4.0]dec-5-ene and mixtures thereof.

A NC composite according to the present invention may further comprise a photoinitator from 0 to 6% by weight of the total weight of the composite, preferably from 0.01 to 3%, more preferably from 0.01 to 2%.

NC composites according to the present invention are solid after the cure at room temperature.

A NC-composite according to the present invention has NCs embedded into the polymer matrix. NCs are solid and integral part of the network structure. The structure allows maintenance of the optical properties of the NCs. Furthermore, this structure allows to achieve high loadings due to the high compatibility of the NCs with the polymeric matrix. In addition to above, the structure provides high thermal stability and moisture stability. The polymeric matrix according to the present invention provides better protection against oxidation and/or other degradation processes.

The NCs suitable for use in the present invention are prepared by using known processes from the literature or acquired commercially. Suitable NCs can be prepared in several ways of mixing all reactants together.

The NC composites according to the present invention can be produced from the various NCs with various different kind of ligands. The present invention does not involve a ligand exchange step.

The NC composites according to the present invention can be prepared in several ways of mixing all ingredients together.

In one embodiment, the preparation of the NC composites according to the present invention comprises following steps:

adding catalyst;
adding epoxy;
adding (meth)acrylate;
adding NCs to polythiol;
adding NCs in polythiol to epoxy/(meth)acrylate mixture; and
curing with UV light and/or electron beam and/or temperature.

Thermal curing temperature is preferably from 10° C. to 250° C., more preferably from 20° C. to 120° C. In addition, thermal curing time is preferably from 10 seconds to 24 hours, more preferably from 1 minute to 10 hours and even more preferably from 1 minute to 15 minutes.

Photocuring UV intensity is preferably from 1 to 1000 mW/cm², more preferably from 50 to 500 mW/cm². In addition, photocuring time is preferably from 1 second to 500 seconds, more preferably from 1 second to 60 seconds.

An UV cure intensity of the nanocrystal composite according to the present invention is from 1 to 2000 mW/cm², preferably from 50 to 500 mW/cm². An UV cure time of the nanocrystal composite according to the present invention is from 0.5 second to 500 seconds, preferably from 1 second to 120 seconds, more preferably from 1 second to 60 seconds.

The Applicant has found out that after thermal and photothermal aging of the NC epoxy thiol (meth)acrylate composite films according to the present invention, the edge ingress observed is very small from 0 to 0.8 mm, compared to the edge ingress of the commercially available film from 1 to 3 mm.

The polymerisation of the matrix takes a place in the presence of NCs and at the same time the NCs are fixed into the matrix. This way, the benefits of the resin matrix are provided to the NCs. In more details, the NCs are functionalized by the thiols, when they are mixed on the adhesive, subsequently the adhesive is gelled by the cure of the mathacrylate part and followed by the formation of the Thiol-NC-epoxy network.

The present invention also encompasses a cured nanocrystal composite according to the present invention.

The present invention also relates to a film comprising a nanocrystal composite according to the present invention, wherein said film comprises a first barrier film and a second barrier film, wherein said nanocrystal composite is between the first and second barrier film.

First and second barrier films can be formed of any useful film material that can protect the NCs from environmental conditions, such as oxygen and moisture. Suitable barrier films include for example polymers, glass or dielectric materials. Suitable barrier layer materials for use in the present invention include, but are not limited to, polymers such as polyethylene terephthalate (PET); oxides such as silicon oxide (SiO₂, Si₂O₃), titanium oxide (TiO₂) or aluminum oxide (Al₂O₃); and mixtures thereof.

In various embodiments each barrier layer of the NC film includes at least two layers of different materials or compositions, such that the multi-layered barrier eliminates or reduces pinhole defect alignment in the barrier layer, providing an effective barrier to oxygen and moisture penetration into the NC material. The NC film can include any suitable material or combination of materials and any suitable number of barrier layers on either or both sides of the NC composite material. The materials, thickness, and number of barrier layers will depend on the particular application, and will be chosen to maximize barrier protection and brightness of the NC while minimizing thickness of the NC film.

In various embodiments first and second barrier layers are a laminate film, such as a dual laminate film, where the thickness of first and second barrier layer is sufficiently thick to eliminate wrinkling in roll-to-roll or laminate manufacturing processes. In one preferred embodiment the first and second barrier films are polyester films (e.g., PET) having an oxide layer.

The present invention also relates to a product comprising a nanocrystal composite according to the present invention, wherein said product is selected from the group consisting of a display device, a light emitting device, a photovoltaic cell, a photodetector, an energy converter device, a laser, a sensor, a thermoelectric device, a security ink, lighting device and in catalytic or biomedical applications.

The present invention also relates to use of nanocrystal composite according to the present invention as a source of photoluminescence or electroluminescence.

The present invention also relates to a product comprising a film comprising a nanocrystal composite according to the present invention, wherein said film comprises a first barrier film and a second barrier film, wherein said nanocrystal composite is between the first and second barrier film, and wherein said product is selected from the group consisting of a display device, a light emitting device, a photovoltaic cell, a photodetector, an energy converter device, a laser, a sensor, a thermoelectric device, a security ink, lighting device and in catalytic or biomedical applications.

Nanocrystal composite films prepared according the present invention demonstrate good protection of nanocrystals. The quantum yield obtained with the present invention is very high. The polymer matrix prepared according to the current invention offers good protection of the nanocrystals again oxygen and moisture permeation and degradation. The examples below demonstrates the high quantum yield and good edge protection of the current invention.

### EXAMPLES

### Examples 1-3

### Methacrylate Epoxy Thiol (Dual Cure)

Masterbatch of Amicure DBUE in Thiocure TMPMP was prepared by mixing 0.05 g of Amicure DBUE and 0.95 g of Thiocure TMPMP together in Speedmixer cup and Speedmix for 1 minute at 3000 rpm.
Samples were prepared by following method:
Base catalyst solution in polythiol was prepared (DBU in TMPMP).

Part A was prepared by mixing the epoxy resin, the acrylate and the photoinitiator.

Part B was prepared by mixing the multifunctional thiol, the NC dispersion and the base catalyst solution.

Part A and Part B were mixed together.

NC film was coated between two barrier layers.

Methacrylate portion was cured by UVA 1 J/cm2.

Epoxy thiol network was formed by thermal cure (5 min 100° C.).

Ingredients of Part B were mixed together to form uniform dispersion. Part A were weighed in and mixture were mixed again. Quantum dot film was prepared in between barrier films and cured by UVA 1 J/cm² followed by thermal cure at 100° C. for 5 min. The optical properties of the cured quantum dot films were evaluated.

| | Example 1 | Example 1 | Example 2 | Example 2 | Example 3 | Example 3 |
|---|---|---|---|---|---|---|
| | Part A | Part B | Part A | Part B | Part A | Part B |
| Description | Weight (g) | Weight (g) | Weight (g) | Weight (g) | Weight (g) | Weight (g) |
| Epoxy resin | 1.565 | | 1.2 | | 1.2 | |
| D.E.R. 331 from Dow | | | | | | |
| Trimethylol-propane | 0.422 | | | | | |
| trimethacrylate SR 350 | | | | | | |
| Epoxy methacrylate | | | 0.433 | | | |
| CN154 from from Sartomer | | | | | | |
| NK-ESTER-DCP | | | | | 0.433 | |
| Tricyclodecane dimethanol | | | | | | |
| dimethacrylate | | | | | | |
| Photoinitiator Irgacure TPO | 0.014 | | 0.014 | | 0.014 | |
| Polythiol | | 1.186 | | | | |
| Thiocure ® TMPMP, from | | | | | | |
| Bruno Bock | | | | | | |
| Polythiol | | | | 1.201 | | 1.201 |
| Thiocure TEMPIC, from | | | | | | |
| Bruno Bock | | | | | | |
| Amicure DBUE in Thiocure | | 0.064 | | 0.057 | | 0.057 |
| TMPMP | | | | | | |
| Nanosys Green Gen 2 QD | | 0.172 | | 0.154 | | 0.154 |
| Concentrate | | | | | | |

| | Example 1 | Example 2 | Example 3 |
|---|---|---|---|
| Quantum yield (by | 0.84 | 0.84 | 0.86 |
| Hamamatsu) | | | |

The quantum yield was measured with a Hamamatsu Absolute PL Quantum Yield Measurement System C-9920. The system contains an integrating sphere and allows the measurement of an absolute quantum yield value for film samples. Very high quantum yield was obtained, demonstrating good compatibility of the current adhesive with the quantum dots.

The NC composites according to the present invention were compared with a commercial Quantum dot enhancement film (QDEF), which was removed from the commercially available touch screen device. This commercial QDEF comprises quantum dots embedded in an adhesive matrix and sandwiched between two barrier films.

The NC composite film was punched into ¾″ (1.9 cm) diameter circles and aged in humidity chamber at 60° C./90% RH to assess the reliability of the NC composite film. Subsequently, the samples were excited with blue light, and dark inactive regions at the edges were observed in the microscope, and measured. The following table shows the width of the inactive edge area during aging.

| | Week 1 | Week 2 | Week 3 | Week 4 | Week 5 | Week 6 |
|---|---|---|---|---|---|---|
| Commercially | 0.966 mm | 1.100 mm | 1.203 mm | | 1.58 mm | |
| available QDEF | | | | | | |
| Example 1 | 0.804 mm | 0.804 mm | 0.878 mm | 0.878 mm | 0.845 mm | 0.846 mm |
| Example 3 | 0.556 mm | 0.571 mm | 0.571 mm | 0.553 mm | 0.557 mm | 0.598 mm |

The adhesive matrix in the above examples clearly offers better protection to NCs compared a commercial product on the market.

What is claimed is:

1. A nanocrystal composite comprising:
a) a plurality of nanocrystals comprising a core comprising a metal or a semiconductive compound or a mixture thereof and at least one ligand, wherein said core is surrounded by at least one ligand,
b) a polymeric matrix, wherein said polymeric matrix is formed by radical polymerisation of (meth)acrylate having functionality from 2 to 10 and thermal induced reaction of epoxy having functionality from 2 to 10 and polythiol having functionality from 2 to 10, and
wherein said nanocrystals are embedded into said polymeric matrix.

2. A nanocrystal composite according to claim 1, wherein said core comprising a metal or semiconductive compound or a mixture thereof is composed of elements selected from combination of one or more different groups of the periodic table.

3. A nanocrystal composite according to claim 1, wherein said core comprises a core and at least one monolayer or multilayer shell or wherein said core comprises a core and at least two monolayer and/or multilayer shells.

4. A nanocrystal composite according to claim 1, wherein said (meth)acrylate has a functionality from 2 to 6.

5. A nanocrystal composite according to claim 1, wherein said (meth)acrylate is selected from the group consisting of 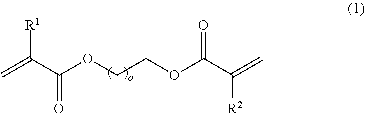
wherein o is 2-10, R¹ and R² are same or different and are independently selected from H, —CH₃, or —C₂H₅; 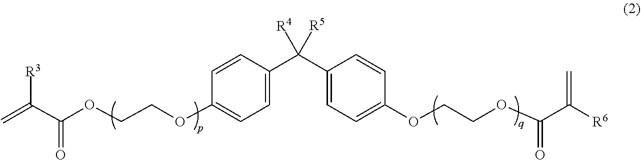
wherein p is 0-10, q is 0-10, R³, R⁴, R⁵ and R⁶ are same or different and are independently selected from H, —CH₃, or —C₂H₅; 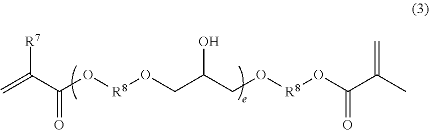
wherein e is 0-10, q is 0-10, R⁷ is selected from H, —CH₃, or —C₂H₅; R⁸ is selected from 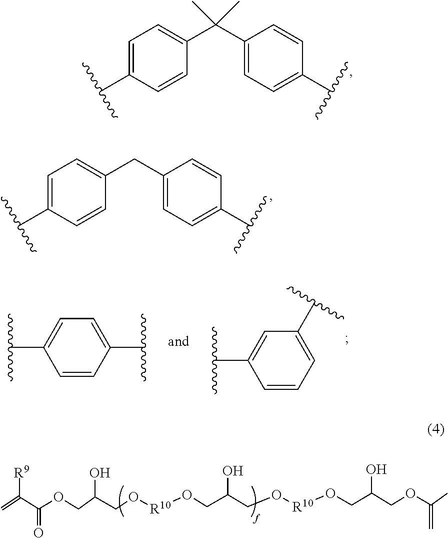
wherein f is 0-10, q is 0-10, R⁹, is selected from H, —CH₃, or —C₂H₅; R¹⁹ is selected from 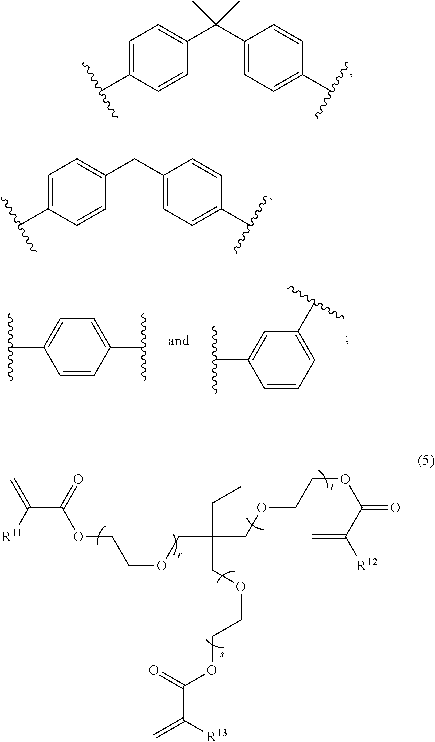
wherein r is 0-10, s is 0-10, t is 0-10, R¹¹, R¹² and R¹³ are same or different and are independently selected from H, —CH₃, or —C₂H₅; 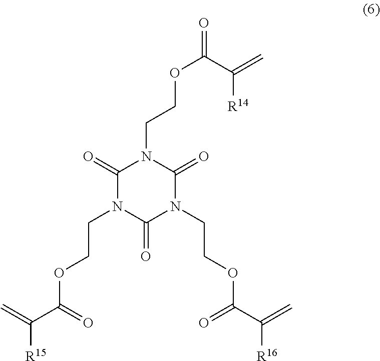
wherein, R¹⁴, R¹⁵ and R¹⁶ are same or different and are independently selected from H, —CH₃, and —C₂H₅; 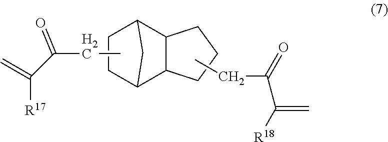
wherein, R¹⁷ and R¹⁸ are same or different and are independently selected from H, —CH₃, or —C₂H₅; 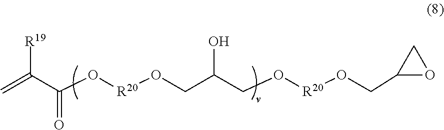
wherein v is 0-10, q is 0-10, R¹⁹, is selected from H, —CH₃, and —C₂H₅; R²⁰ is selected from 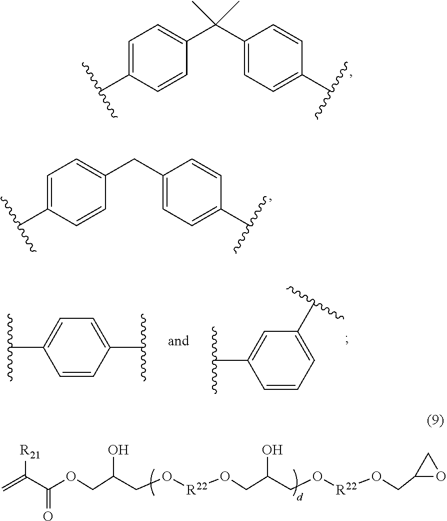
wherein d is 0-10, q is 0-10, R²¹ is selected from H, —CH₃, and —C₂H₅; R²² is selected from 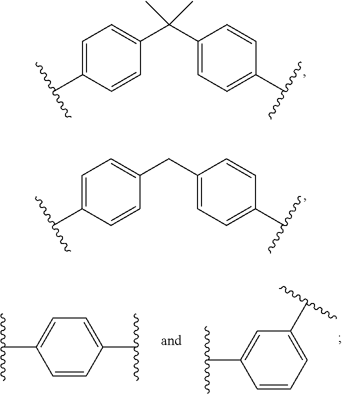 [SMILES: *c1ccc(C(C)(C)c2ccc(*)cc2)cc1 ; *c1ccc(Cc2ccc(*)cc2)cc1 ; *c1ccc(*)cc1 ; *c1cccc(*)c1]
and mixtures thereof.

6. A nanocrystal composite according to claim 1, wherein said polythiol has a functionality from 2 to 6.

7. A nanocrystal composite according to claim 1, wherein said polythiol is selected from the group consisting of 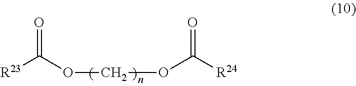
wherein n is 2-10, R²³ and R²⁴ are same or different and are independently selected from —CH₂—CH(SH)CH₃ and —CH₂—CH₂—SH; 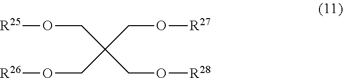
wherein R²⁵, R²⁶, R²⁷ and R²⁸ are same or different and are independently selected from —C(O)—CH₂—CH₂—SH, —C(O)—CH₂—CH(SH)CH₃,
—CH₂—C(—CH₂—O—C(O)—CH₂—CH₂—SH)₃, —C(O)—CH₂—SH, —C(O)—CH(SH)—CH₃; 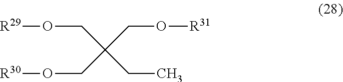
wherein R²⁹, R³⁹ and R³¹ are same or different and are independently selected from —C(O)—CH₂—CH₂—SH, —C(O)—CH₂—CH(SH)CH₃,
—[CH₂—CH₂—O—]ₒ—C(O)—CH₂—CH₂—SH, —C(O)—CH₂—SH, —C(O)—CH(SH)—CH₃ and o is 1-10; 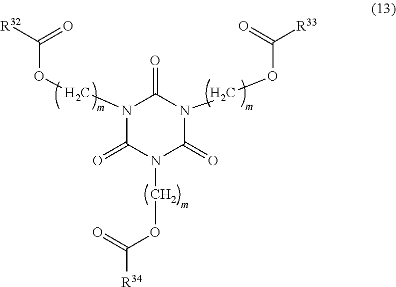
wherein m is 2-10, R³², R³³ and R³⁴ are same or different and independently selected from —CH₂—CH₂SH, —CH₂—CH(SH)CH₃, —C(O)—CH₂—SH, —C(O)—CH(SH)—CH₃, and mixtures thereof.

8. A nanocrystal composite according to claim 1, wherein said epoxy has a functionality from 2 to 6.

9. A nanocrystal composite according to claim 1, wherein said epoxy is selected from the group consisting: 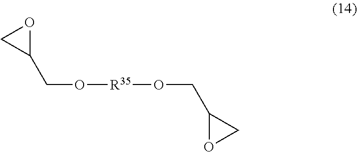
wherein R³⁵ is selected from 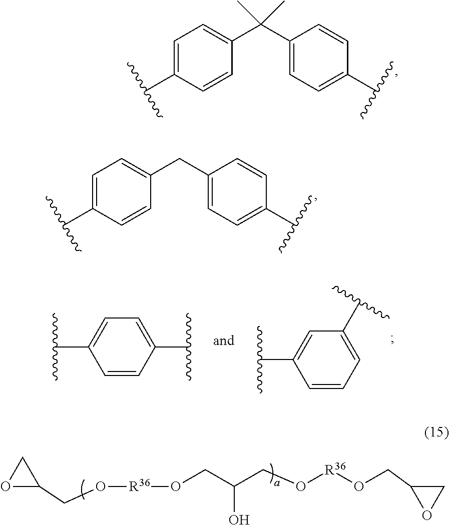
wherein a is 2-10 and R³⁶ is selected from 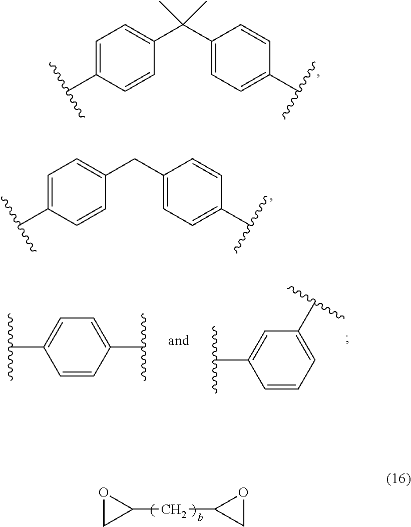
wherein b is 2-10; 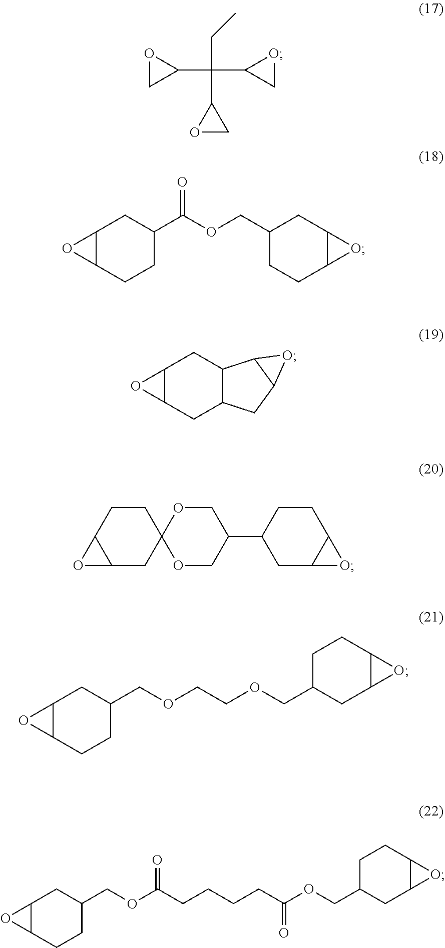 [SMILES: CCC(C1CO1)(C1CO1)C1CO1 ; O=C(OCC1CCC2OC2C1)C1CCC2OC2C1 ; C1C2CC3OC3C2CC2OC12 ; C1CC2OC2CC1C1COC2(CCC3OC3C2)OC1 ; C(COCC1CCC2OC2C1)OCC1CCC2OC2C1 ; O=C(CCCCC(=O)OCC1CCC2OC2C1)OCC1CCC2OC2C1]
and mixtures thereof.

10. A nanocrystal composite according to claim 1 comprising nanocrystals from 0.01 to 10% by weight of the total weight of the composite.

11. A nanocrystal composite according to claim 1 comprising a polymer matrix from 90 to 99.99% by weight of the total weight of the composite.

12. A cured nanocrystal composite according to claim 1.

13. A film comprising a nanocrystal composite according to claim 1, wherein said film comprises a first barrier film and a second barrier film, wherein said nanocrystal composite is between the first and second barrier film.

14. A product comprising a nanocrystal composite according to claim 1, wherein said product is selected from the group consisting of a display device, a light emitting device, a photovoltaic cell, a photodetector, an energy converter device, a laser, a sensor, a thermoelectric device, a security ink, lighting device and in catalytic or biomedical applications.

15. A nanocrystal composite according to claim 1, wherein said metal or semiconductive compound is a combination of one or more elements selected from the group IV; one or more elements selected from the groups II and VI; one or more elements selected from the groups III and V; one or more elements selected from the groups IV and VI; one or more elements selected from the groups I and III and VI or a combination thereof.

16. A nanocrystal composite according to claim 1, wherein said metal or semiconductive compound is selected from the group consisting of Si, Ge, SiC, SiGe, CdS, CdSe, CdTe, ZnS, ZnSe ZnTe, ZnO, HgS, HgSe, HgTe, MgS, MgSe, GaN, GaP, GaSb, AlN, AlP, AlAs, AlSb₃, InN₃, InP, InAs, SnS, SnSe, SnTe, PbS, PbSe, PbTe, CuInS₂, CuInSe₂, CuGaS₂, CuGaSe₂, AgInS₂, AgInSe₂, AgGaS₂ and AgGaSe₂.

17. A nanocrystal composite according to claim 1, wherein said metal or semiconductive compound is selected from group consisting of CdSe, InP and mixtures thereof.

18. A nanocrystal composite according to claim 1, wherein said polythiol is selected from the group consisting of glycol di(3-mercaptopropionate), pentaerythritol tetrakis (3-mercaptobutylate), 1,3,5-tris(3-mercaptobutyloxethyl)-1,3,5-triazine-2,4,6(1H,3H,5H)-trione, 1,4-bis (3-mercaptobutylyloxy) butane, tris[2-(3-mercaptopropionyloxy)ethyl]isocyanurate, pentaerythritol tetra(3-mercaptopropionate), trimethylolpropane tris(3-mercaptopropionate), trimethylolpropane tris(3-mercaptobutyrate), ethoxylated-trimethylolpropan tri-3-mercaptopropionate, dipentaerythritol hexakis (3-mercaptopropionate) and mixtures thereof.

19. A nanocrystal composite according to claim 1, wherein said polythiol is primary thiol, selected from the group consisting of glycol di(3-mercaptopropionate), tris[2-(3-mercaptopropionyloxy)ethyl]isocyanurate, pentaerythritol tetrakis(3-mercaptopropionate), trimethylolpropane tris(3-mercaptopropionate), ethoxylated-trimethylolpropan tri-3-mercaptopropionate, dipentaerythritol hexakis (3-mercaptopropionate) and mixtures thereof.

20. A nanocrystal composite according to claim 1 wherein said polythiol is selected from the group consisting of tris[2-(3-mercaptopropionyloxy)ethyl]isocyanurate, pentaerythritol tetra(3-mercaptopropionate), trimethylolpropane tris(3-mercaptopropionate) and mixtures thereof.
